(19) United States
(12) Patent Application Publication
(10) Pub. No.: US 2026/0336370 A1
(43) Pub. Date: Oct. 29, 2026

(54) ROOF BOW

(71) Applicants: NISSAN NORTH AMERICA, INC., Franklin, TN (US); NISSAN MOTOR CO., LTD., Yokohama-shi, Kanagawa (JP)

(72) Inventors: Yoshio MUTA, Atsugi, Kanagawa (JP); Yutaka YANO, Fujisawa, Kanagawa (JP); Seiichirou NAGANO, Atsugi, Kanagawa (JP); Luke CORDES, Bloomfield, MI (US); Srinkanth BADDAM, Northville, MI (US); David KOVIE, Livonia, MI (US); Ronald MORROW, Novi, MI (US)

(21) Appl. No.: 19/187,964

(22) Filed: Apr. 23, 2025

(51) Int. Cl. B60J 5/10; B62D 25/06; E05F 15/63

(52) U.S. Cl. CPC B60J 5/106; B62D 25/06; E05F 15/63

(57) ABSTRACT

A roof bow structure of a vehicle includes a cross member disposed below a roof panel of the vehicle, the cross member having an exterior surface, a first side portion, a middle portion and a second side portion, and a hinge attached to the exterior surface of the cross member.

### BACKGROUND

### Technical Field

The present disclosure generally relates to a roof bow. More specifically, the present disclosure relates to roof bow disposed to provide structural support for a roof module and a roof of a vehicle.

### Background Information

Rear door assemblies of vehicles such as SUVs (sport utility vehicles) typically pivot rearward and upward. A hinge generally couples an electric motor to a portion of the rear door in order to move the rear door between open and closed orientations.

### SUMMARY

It has been discovered that it is desirable to protect the rear door lifting components from the exterior environment. In other words, it is desirable to protect the motor and hinge assembly configured to operate a vehicle rear door from weather, debris and other elements. However, positioning these components beneath or under the roof can restrict access and make any replacement or repair of the components difficult. Therefore, it has been determined that improving access to these component can be important to the lifespan of the rear door lifting components and the rear door of the vehicle itself.

Moreover, it has bee determined that it id desirable to improve a structural support for the roof module and the roof of the vehicle. The structural support should be light weight, while simultaneously providing sufficient structural support,

In view of the state of the known technology, one aspect of the present disclosure is to provide a roof bow structure of a vehicle, comprising a cross member configured to be disposed below a roof panel of the vehicle, the cross member having an exterior surface, a first side portion, a middle portion and a second side portion, and a hinge attached to the exterior surface of the cross member.

Another aspect of the present disclosure is to provide a vehicle body structure, comprising a roof structure, a rear door opening, a roof panel, a cross member configured to be disposed below the roof panel of the vehicle body structure, the rear cross member having an exterior surface, and a hinge attached to the exterior surface of the cross member.

By providing the disclosed structure and embodiments, it is possible to improve access to the rear door lifting components which can be important to the lifespan of the rear door lifting components and the rear door of the vehicle itself.

### BRIEF DESCRIPTION OF THE DRAWINGS

Referring now to the attached drawings which form a part of this original disclosure:

FIG. 1 is a partial side view of a vehicle with a rear door that is operated by components disposed beneath a roof module according to an embodiment of the present disclosure;

FIG. 2 is a partial side view of the rear door being operated by the components disposed beneath a roof module according to the embodiment of FIG. 1;

FIG. 3 is a partial side view of the rear door of the embodiment of FIG. 1 in an opened configuration;

FIG. 4 is a top view of the embodiment of FIG. 1 with the rear door removed;

FIG. 5 is a side view in section of the roof module according to one embodiment;

FIG. 6 is a perspective view in section of the roof module according to one embodiment;

FIG. 7 is a perspective view in section of the roof module according to one embodiment;

FIG. 8 is an exploded perspective view of the roof module according to one embodiment;

FIG. 9 is a bottom perspective view of the cover of the roof module according to one embodiment;

FIG. 10 is a partial view illustrating the bottom side of the roof module of FIG. 1;

FIG. 11 is a top perspective view of the roof module with the cover removed;

FIG. 12 is a top view of the roof module with the cover removed;

FIG. 13 is an enlarged view of the connection between the cover of the roof module and the hinge structure;

FIG. 14 is an enlarged view of the hinge structure with the cover of the roof module removed;

FIG. 15 is a top view of the motor and hinge mounting structures disposed beneath the cover of the roof module;

FIG. 16 is an exploded view of the bow structure of the roof module;

FIG. 17 is an exploded view of the bow structure and the roof module;

FIG. 18 is a top perspective view of the bottom portion of the roof bow; and

FIG. 19 is a cross sectional perspective view of the roof bow.

It should be noted that these figures are intended to illustrate the general characteristics of methods, structure and/or materials utilized in certain illustrative embodiments and to supplement the written description provided below. These drawings are not to scale and may not precisely reflect the precise structural or performance characteristics of any given embodiment and should not be interpreted as defining or limiting the range of values or properties encompassed by illustrative embodiments unless specified.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the disclosure as defined by the appended claims and their equivalents.

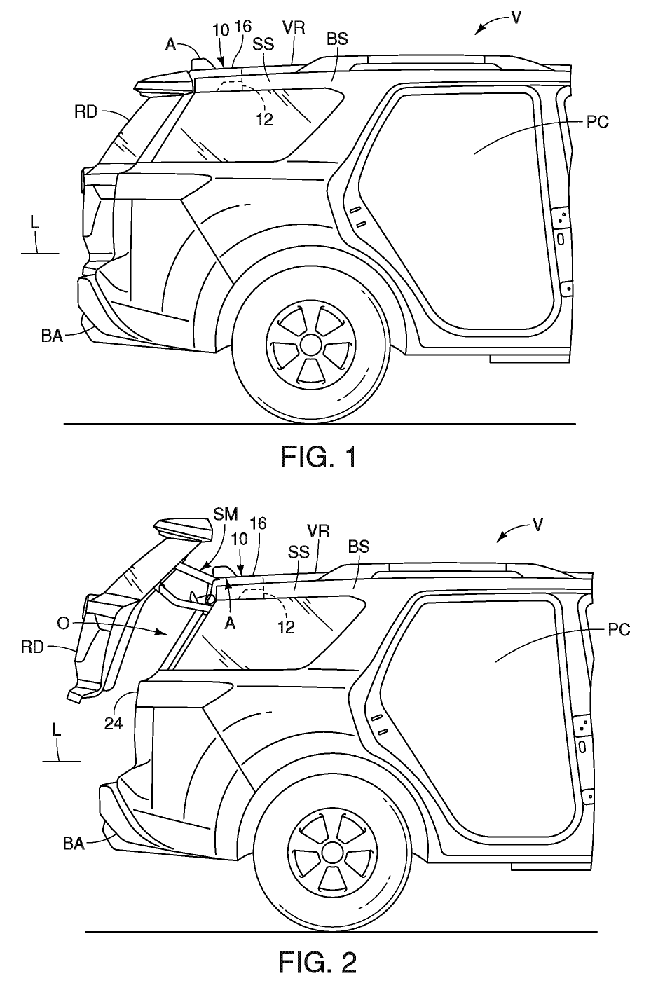

Referring initially to FIGS. 1-3, a vehicle V having a roof module 10 according to one embodiment is illustrated. The rood module 10 is supported by a roof bow 12. .In this embodiment, the roof module 10 includes a roof panel 14 and a cover 16. The roof module 10 is disposed at a rear portion of the vehicle roof (roof structure) VR and is configured to facilitate access to components for operating the rear door RD of the vehicle V. As can be seen in FIGS. 1-3, the vehicle V includes a rear door RD. The rear dear is operated from a closed position to an open position using rear door RD operating components. The rear door RD can be considered a “liftgate” or a “hatchback” door or any other suitable terminology. Moreover, the roof module 10 can enable access to any suitable door that operates as described herein.

In one embodiment, the rear door operating components include, but are not limited to, a motor M and a hinge structure HS. As discussed in more detail below the rear door RD operating components are disposed under or beneath the cover 16 of the roof module 10.

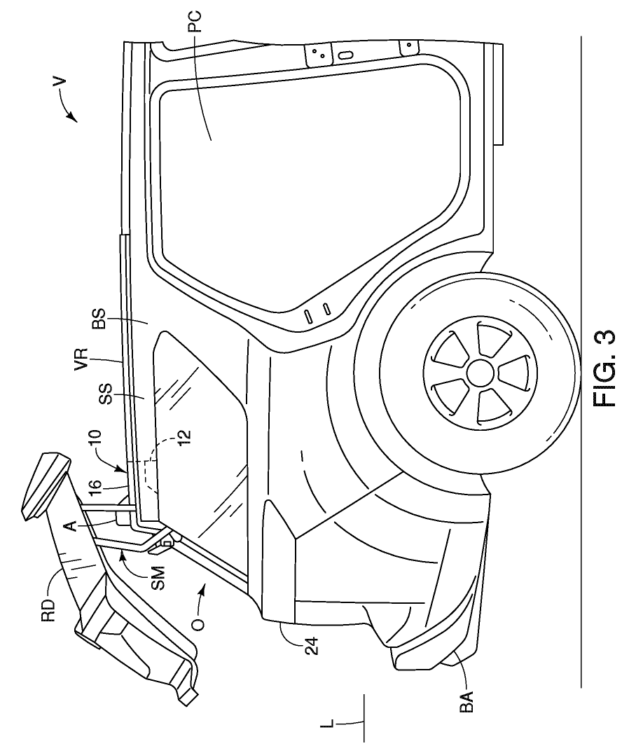

The rear door RD assembly is attached to the vehicle body structure BS by, for instance, a four-bar support mechanism SM (also referred to as a pivoting bar mechanism or a door linkage assembly) that also movably supports the rear door RD of the vehicle body structure BS when the electric motor M is operated. The four-bar support mechanism SM is kinematically dimensioned and configured to move the rear door RD of the vehicle V from a closed orientation shown in FIG. 1 to intermediate orientations shown for example in FIG. 2 and eventually to a fully open orientation shown in FIG. 3. It should be understood from the drawings and the description herein that the four-bar support mechanism SM can be replaced with other support mechanisms that do not include four bars, such as a two-bar mechanism that pivots about a single axis of rotation in order to support the rear door RD for movement between a closed orientation and an open orientation.

The vehicle body structure BS includes, among other features, side structures SS, the vehicle roof VR (a roof structure) and a rear structure RS that are all rigidly connected to one another by, for example, various welding techniques. When the rear door RD is in the closed orientation, the rear door RD covers the rear door opening O, as shown in FIG. 1. When the rear door RD is in the open orientation, the rear door opening O is fully exposed, as shown in FIG. 3.

The rear door assembly, and in particular, the four bar-support mechanism SM of the rear door assembly, is configured such that the rear door RD remains very close to the rear structure RS and the vehicle roof VR during movement of the rear door RD between the closed orientation and the open orientation.

Specifically, when the rear door RD is in the intermediate orientation shown in FIG. 2, a lower end of the rear door RD moves a maximum distance away from the rear structure RS with little or no further rearward displacement as the rear door RD moves upward to an open orientation. More specifically, during the opening movement of the rear door RD, more than three quarters of the entire rear door RD can be located above and forward of a rearmost point from the fascia of a bumper assembly relative to a vertical plane, as shown in FIG. 2. In other words, only a very small percentage of the rear door RD is displaced rearward of the bumper assembly BA. This enables a person to be capable of standing only a short distance away from the rear structure RS of the vehicle V during opening and closing of the rear door RD.

This rear door RD is moved using the hinge structure HS and the motor M. It has been determined that it is desirable to provide access to the hinge structure HS and motor M, among other components to improved maintenance, repair and replacement of these elements. Such access can improve and simplify maintenance, repair and replacement and reduce costs. Moreover, access to the hinge structure HS and motor M, among other components can increase the likelihood of maintenance, repair and replacement thus improving component and vehicle lifespan.

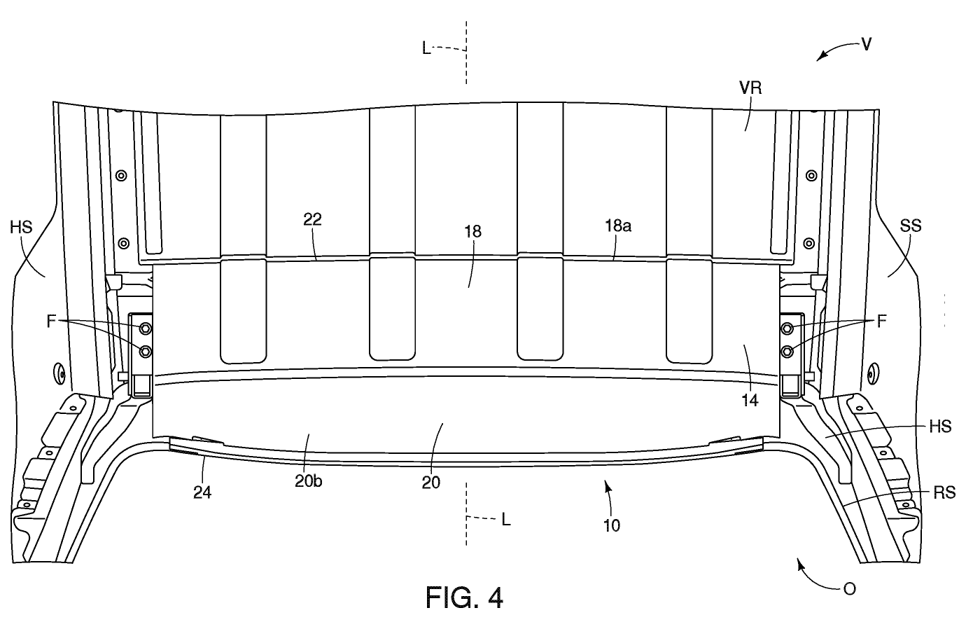

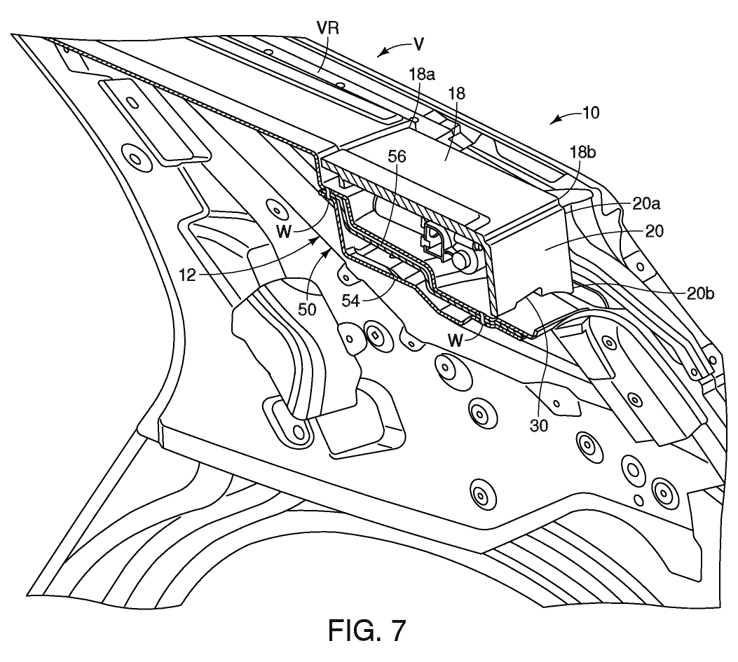

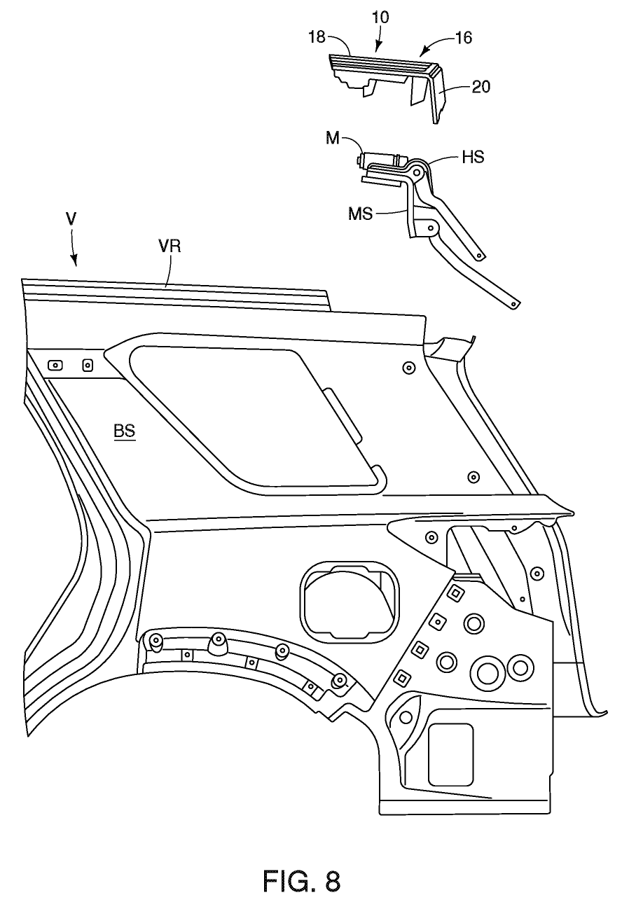

In one embodiment, these components are accessible by removal of the cover 16. As can be seen in FIGS. 4-9, the cover 16 includes a first portion 18 having a first end 18a and a second end 18b and a second portion 20 having a first end 20a and a second end 20b. The first end 18a of the first portion 18 is configured to be disposed adjacent a first roof ditch 22 in the vehicle roof VR and the second end 20b of the second portion 20 is configured to be disposed adjacent to a second roof ditch 24 in the vehicle roof VR.

The first portion 18 of the cover 16 is generally planar with the vehicle roof VR and extends in the longitudinal direction L of the vehicle V. The cover 16 can be made from the same material as the roof, such as for example, metal, a composite or any suitable material or combination of materials. The first portion 18 of the cover 16 can extend in a generally front to back direction and appears to be an extension of the vehicle roof VR. The first portion 18 of the cover 16 is generally planar with the vehicle roof VR and continues the general roof line without interruption to provide a seamless extension of the vehicle roof VR, which enhances vehicle aesthetics.

In one embodiment, the cover 16 can include an antenna A. The antenna can be disposed on the first portion 18 of the cover 16. As illustrated in FIGS. 1-3, the antenna can be a shark fin type antenna that is configured to transmit and received wireless communications. As can be understood, the antenna A can be multi-band antenna module designed to combine multiple antenna functions (like AM/FM, GPS, 4G LTE and V2V communications or any other communications desired) into a single, aerodynamic housing.

The first end 20a of the second portion 20 is attached or connected to the second end 18b of the first portion 18 of the cover 16. The second portion 20 can be attached to the first portion 18 in any manner desired. In the present embodiment, the first and second portions 18 and 20 of the cover 16 are unitary and formed as a one piece structure. For example, the first and second portions 18 and 20 can be a metal portion that is formed by pressing into the appropriate configuration or can be molded into the appropriate configuration based on the material or combination of materials.

The second portion 20 of the cover 16 extends from the first end 20a to the second end 20b in a substantially transverse direction from the first portion 18 of the cover 16. Thus, the second portion 20 of the cover 16 extends transverse or perpendicular to the longitudinal direction L of the vehicle V. The second portion 20 can extend in a generally upward and downward direction. This configuration of the second portion 20 of the cover 16 enables the cover 16 to cover a recessed portion 26 in the roof module 10, discussed in more detail below. Moreover, the configuration of the first portion 18 and the second portion 20 of the cover 16 enables the cover 16 to complete the continuation of the vehicle roof VR to the rear door RD. Furthermore, the second portion 20 of the cover 16 is disposed adjacent the rear door RD of the vehicle V to provide a seamless closed configuration for the rear door RD, as shown in FIG. 1. As can be understood, the cover 16 and the recessed portion 26 provide enhanced access to the rear door RD operation elements (e.g., motor M and hinge structure HS) while also providing an aesthetic pleasing configuration that appears to simply be an extension of the vehicle roof VR of the vehicle V.

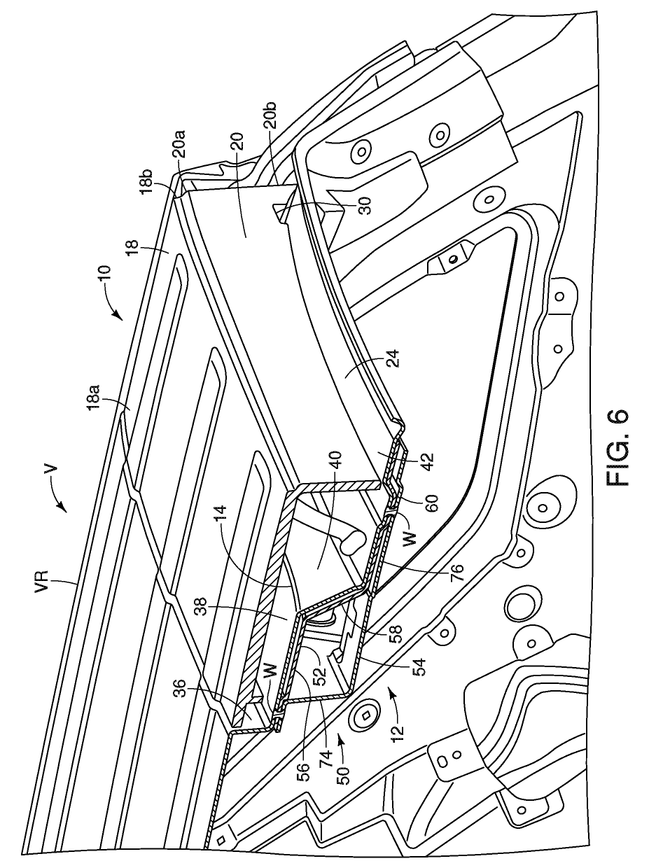

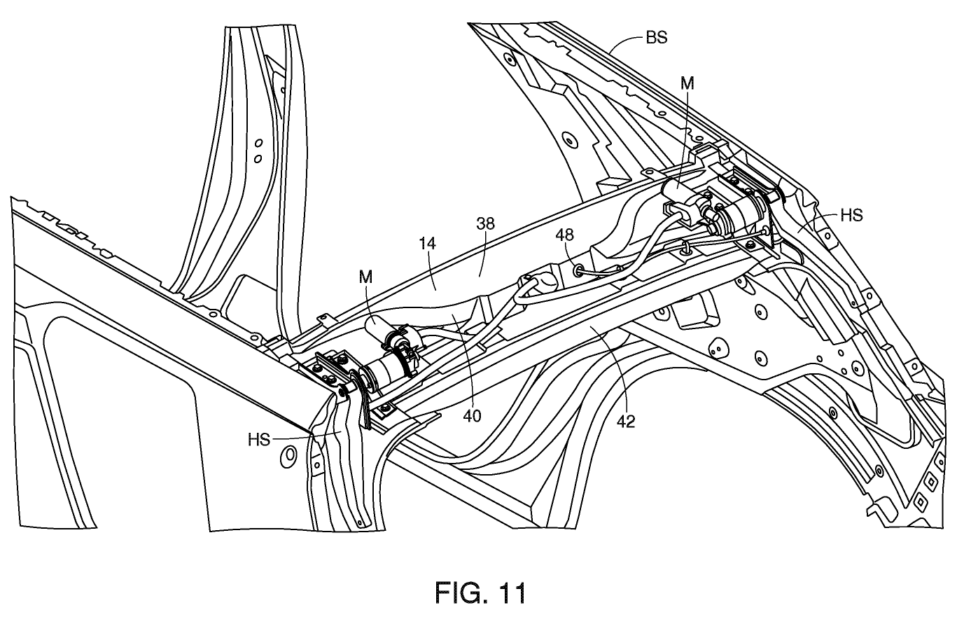

As illustrated in FIGS. 6, 7 and 9 second portion 20 of the cover 16 can include a first drain 28a and a second drain 28b for fluids. In one embodiment, the first and second drains 28a and 28b are rectangular recesses in the bottom end 30 of the second end 18b of the second portion. The first and second drains 28a and 28b enable a portion (e.g., bottom end 30) of the cover 16 to be spaced from the roof panel 14, enabling water and other liquids or material to exit the space between the cover 16 and the roof panel 14. As seen in FIG. 11, the first and second drains 28a and 28b allow the material to drain into second roof ditch 24 and drain off of the roof area.

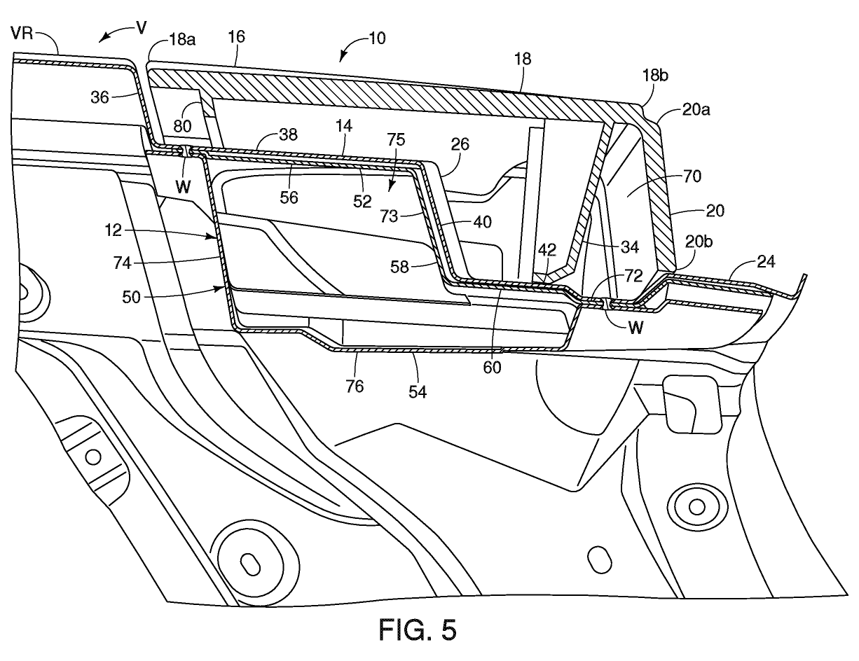

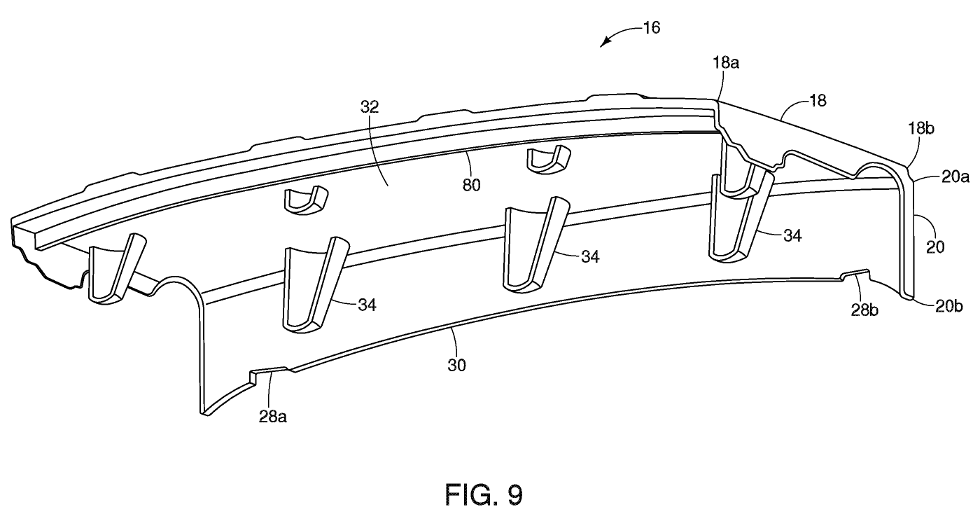

As illustrated in FIGS. 5 and 9, the inner surface 32 of the cover 16 can include fastening elements 34. As can be seen in FIG. 5, the fastening elements 34 are accessible from the interior (e.g., the passenger compartment PC) of the vehicle V. By being only accessible from the interior of the vehicle V, the cover 16 can be easily removable only to a user or person having access to the interior of the vehicle V and difficult to remove without such access. The fastening elements 34 can be any suitable members that would enable the cover 16 to be affixed to the roof panel 14 of the roof module 10. For example, the fastening elements 34 can be screws, snap fit elements or any other suitable type of fastener.

As illustrated in FIGS. 4, 9-11 and 15, first and second hinge structures HS are attached to the roof panel 14 or the second surface 54 of the roof bow 12 using fasteners F and a mounting structure MS. The roof panel 14 can be an extension of the vehicle roof VR. That is, the roof panel 14 can be a continuous metal structure that is uniformly and monolithically formed with the vehicle roof VR. However, the roof panel 14 can be attached in any suitable manner, such as welding and attachment structure, if desired. In one embodiment, the roof panel 14 can be a separate structure from the vehicle roof VR and coupled thereto and/or placed adjacent the vehicle roof VR and provided with a seal to prevent material from passing therebetween.

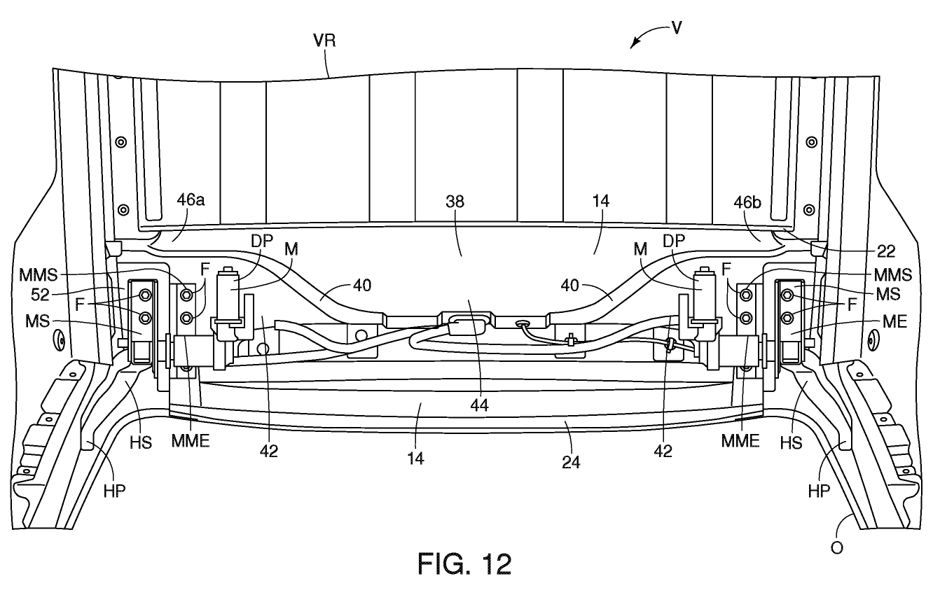

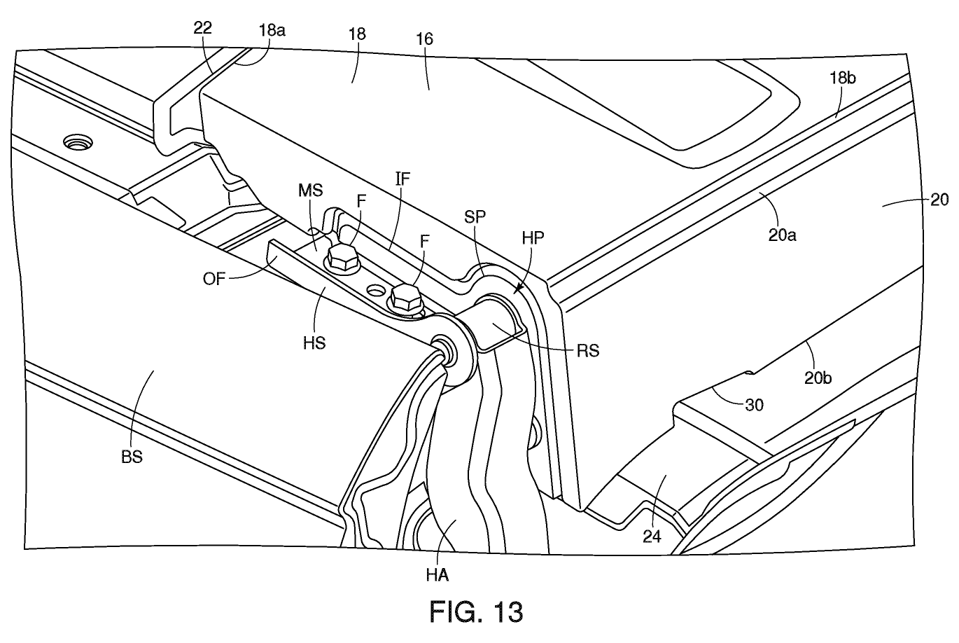

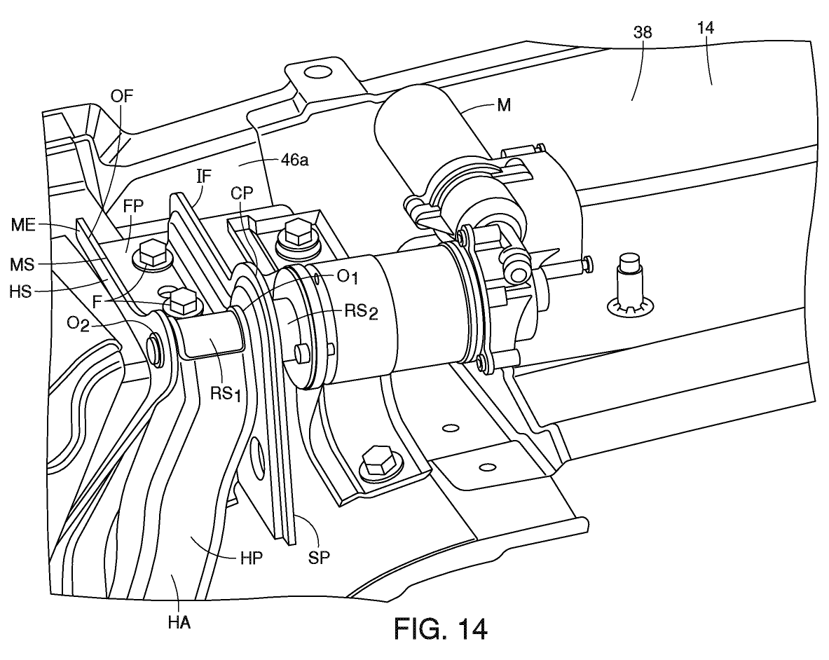

The roof panel 14 and the vehicle roof VR are generally made of metal, but can be any suitable material. As illustrated in FIGS. 5-7, a first portion 36 of the roof panel 14 extends downwardly from the end of the vehicle roof VR. A second portion 38 extend generally parallel to the vehicle roof VR. A third portion 40 extends downwardly at an angle and a fourth portion 42 extends generally parallel to the roof. As shown in FIGS. 12 and 13, the second portion 38 has a curved configuration, such that the central portion 44 of the second portion 38 is closer to the rear door opening O than the ends 46a and 46b of the second portion 38. The second portion 38 can also have openings 48 for electrical wiring and/or hydraulic conduits for the motors M and the hinge structure HSs as can be understood. In one embodiment, the roof panel 14 can be an integral structure and unitarily formed with the remainder of the roof. However, it is noted that the roof panel 14 can be separately formed from the roof and be connected to the roof in any suitable manner.

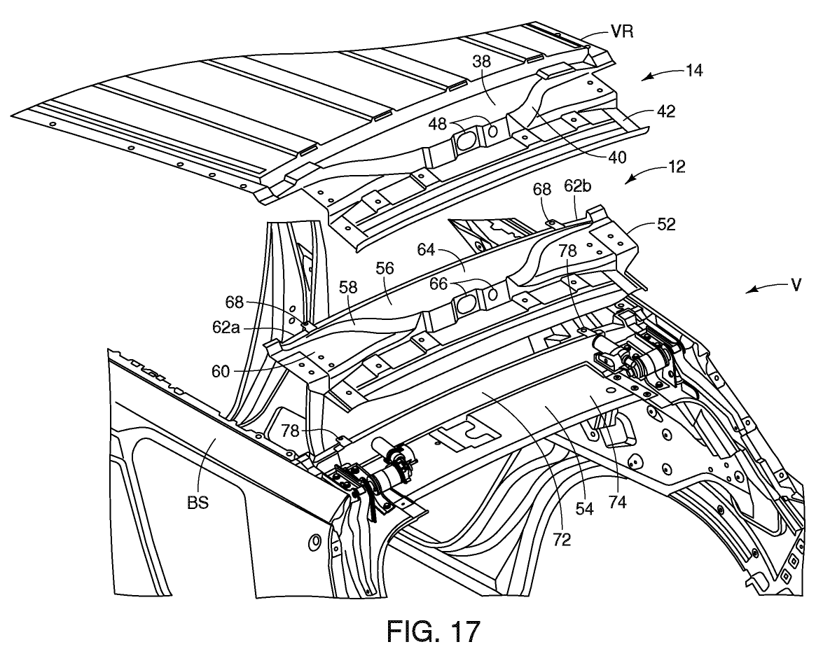

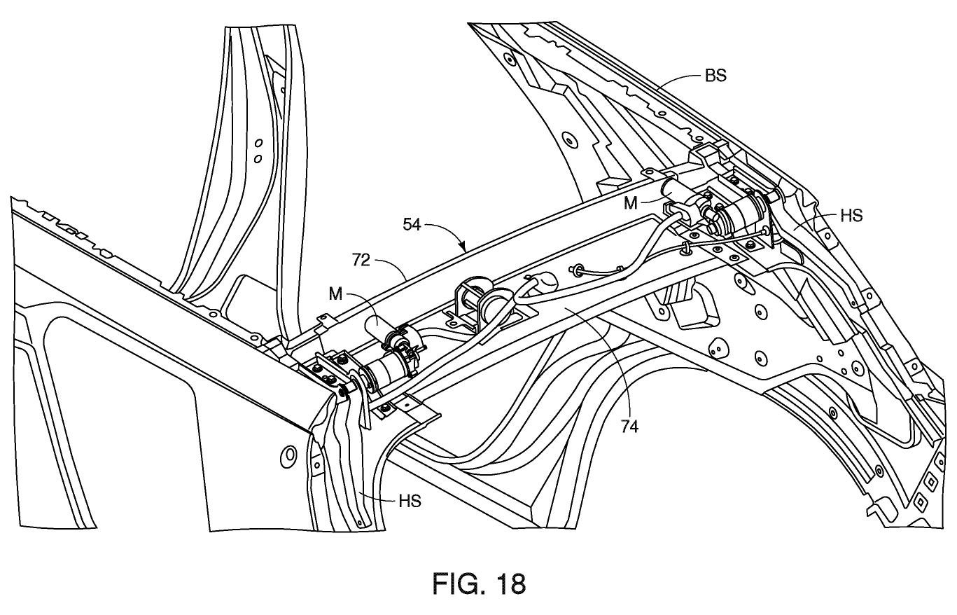

The first and second hinge structures HS can be made from metal or other suitable material. Each of the first and second hinge structures HS include a mounting element ME and a hinge portion. Since the first and second hinge structures HS are basically identical (simply mirrored images), only one hinge structure HS will be described and any description of the first hinge structure HS can apply to the second hinge structure HS. The mounting element ME can be disposed on the fourth portion 42 of the roof panel 14 and adjacent the end of the roof panel 14. Thus, as illustrated in FIGS. 11-14, the hinge structure HS is disposed in the portion (end portion 46a) of the second portion 38 of the roof panel 14 that is farther away from the rear door RD opening than the central portion 44 of the second portion 38. In one embodiment, the hinge structure HS can be attached to the first structure 52 of the roof bow 12, as discussed below. In this embodiment, the hinge structure is attached to the exterior surface of the cross member 50. In this embodiment, the roof panel 14 does not fully extend to the side structures SS of the body structure BS of the vehicle, as shown for example in FIGS. 12 and 17.

The hinge structure can include a mounting element ME that along with a mounting plate MP form the mounting structure MS. The mounting element ME is configured to align with the mounting plate MP (FIG. 15) and enable the hinge structure HS to mount to the first structure 52 of the roof bow 12 or the roof panel 14. In one embodiment, the mounting element ME has two openings that are configured to align with openings in the mounting plate MP using fasteners F, which in turn align with the openings in the first structure 52 of the roof bow 12 or the roof panel 14. As can be understood, the fasteners F for each of the hinge structures HS can pass through the hinge structure HS and into the mounting plate MP. In this embodiment, two fasteners (screws) pass through openings in the mounting element ME of the hinge structure HS and into the mounting plate MP. However, it is noted that any number and type of fasteners can be used to attach the hinge structure HS to the first structure 52 of the roof bow 12 or the roof panel 14.

The hinge structure HS includes an inner flange IF and an outer flange OF. Each of the inner flange IF and the outer flange OF extend transverse to the flat portion FP (with the openings) of the mounting element ME and are configured to improve the rigidity and strength of the hinge structure HS. The inner flange IF and the outer flange OF also have curved or raised portion CP with first and second openings therein O1 and O2. The first opening O1 is disposed in the inner flange IF and the second opening O2 is disposed in the outer flange OF. The first and second openings O1 and O2 are aligned and configured to accept a rotatable shaft RS1.

Thus, in one embodiment, the hinge portion HP includes the raised portion CP of the inner (first) flange IF and the outer (second) flange OF, the rotatable shaft RS1 and a hinge arm HA. The hinge arm HA is coupled to the rotatable shaft RS1, such that when the shaft RS1 is rotated the hinge arm HA is rotated, which in turn opens or closes the rear door RD.

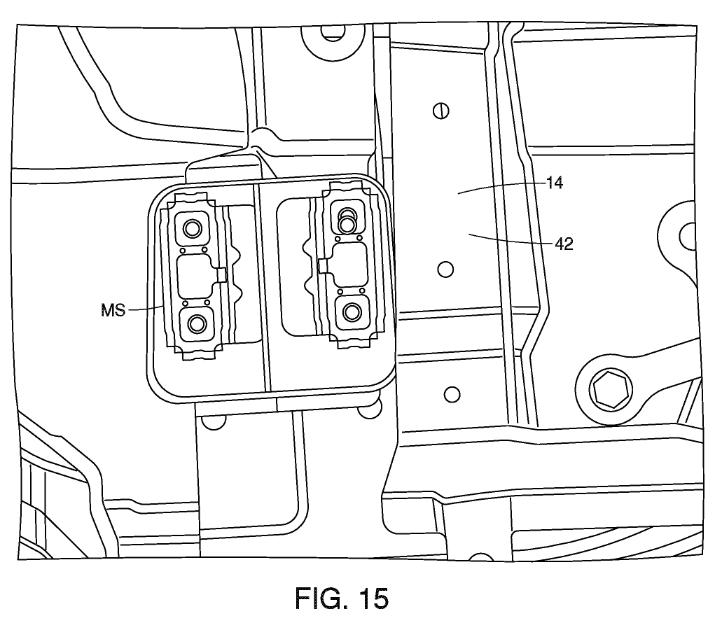

The inner flange IF includes a stepped portion SP that is configured to abut the cover 16, as shown in FIG. 14. The cover 16 is configured to overlap the inner flange IF on the hinge structure HS to provide an overlapping connection with the cover 16. More specifically, the stepped portion SP provides an overlapping connection with the cover 16 and is configured to provide protection from external elements, such as precipitation, dust dirt and other material that may affect the motor M (or other component) operation. In one embodiment a seal can be disposed between the inner flange IF and cover 16.

As illustrated in FIGS. 11, a first motor M and a second motor M are attached to the roof panel 14 using fasteners and a motor mounting structure MMS. Furthermore, the cover 16 is configured to enable the motor M to extend laterally therefrom, the motor M connected to the hinge structure HS. Each of the motors M includes a motor mounting element MME and a drive portion DP. Since the first and second motors M are basically identical (simply mirrored images), only one motor M will be described and any description of the first motor M can apply to the second motor M. The mounting element MME is disposed on the second portion 38 of the roof panel 14 and adjacent the end of the roof panel 14. Thus, as illustrated in FIGS. 11 and 12, the motor M is disposed in the portion (end portion 46a) of the second portion 38 of the roof panel 14 that is farther away from the rear door RD opening than the central portion 44 of the second portion 38. The motor M includes the mounting element MME that along with the mounting plate MP form the motor mounting structure MMS. The mounting element MME is configured to align with the mounting plate MP (FIG. 15) and enable the hinge structure HS to mount to the roof panel 14. In one embodiment, the motor mounting element MME has two openings that are configured to align with openings in the mounting plate MP using fasteners F, which in turn align with the openings in the roof panel 14. As can be understood, the fasteners F for each of the motors M can pass through the motor mounting element MME and into the mounting plate MP. In this embodiment, two fasteners (screws) pass through openings in the motor mounting element MME of the motors M and into the mounting plate MP. However, it is noted that any number and type of fasteners can be used to attach the motors M of the roof panel 14.

The motor M can include a rotatable shaft RS2 that couples to the rotatable shaft RS1 of the hinge structure HS and is configured to be rotated to open and close the rear door RD. As can be understood, the rotatable shaft RS2 for the motor M and the rotatable shaft RS1 for the hinge structure HS can be separate, can be the same and/or or can couple together at any desired location or in any desired manner.

As illustrated in FIGS. 5-7, the roof module 10 operates in conjunction with a roof bow 12 structure. In one embodiment, the roof bow 12 includes the cross member 50 that can support the first and second hinge structures HS. The cross member 50 can include a first structure 52 and a second structure 54. As can be seen in FIG. 17, the first and second structure 52 and 54 extend the width of the vehicle and attach to the outboard sides of the body structure BS. Thus the roof bow 12 forms a cross member and is configured to provide structural rigidity to the vehicle and support the roof model 10 and the vehicle roof VR. The cross member 50 is a rectangular structure when viewed in cross section, that extends with width of the vehicle V and can be attached to the side structures SS of the vehicle body structure BS.

The roof bow 12 provides structural rigidity by forming a generally rectangular structure with an opening or cavity formed therein. As illustrated in FIGS. 5-7, the first and second structures 52 and 54 of the roof bow 12 form the cross member 50 configured to be disposed below the roof panel 14. In one embodiment, the first and second structures 52 and 54 of the roof bow 12 form the cross member 50 and can be welded W at the top thereof.

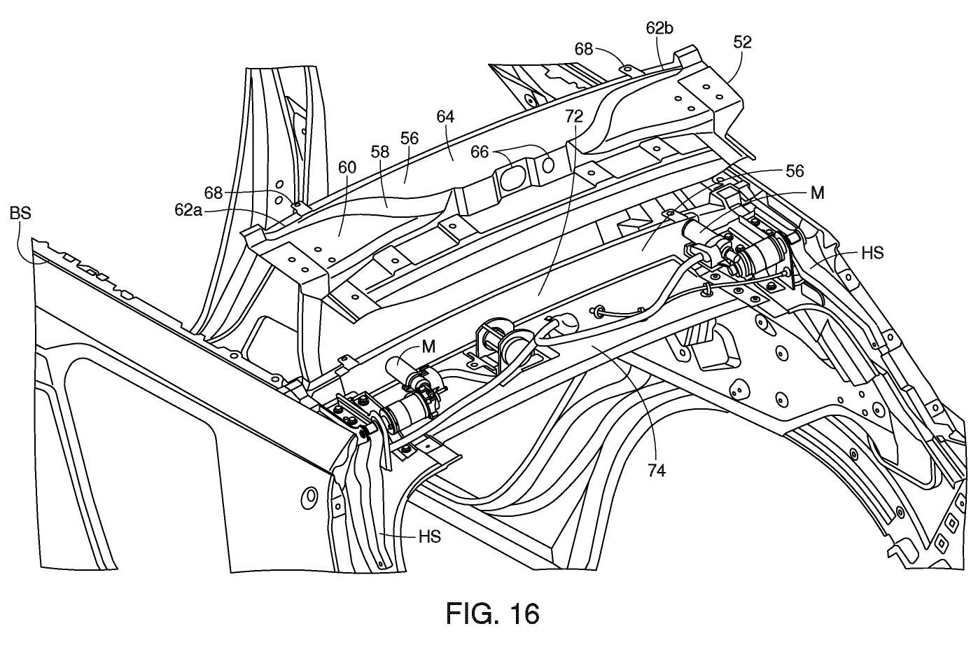

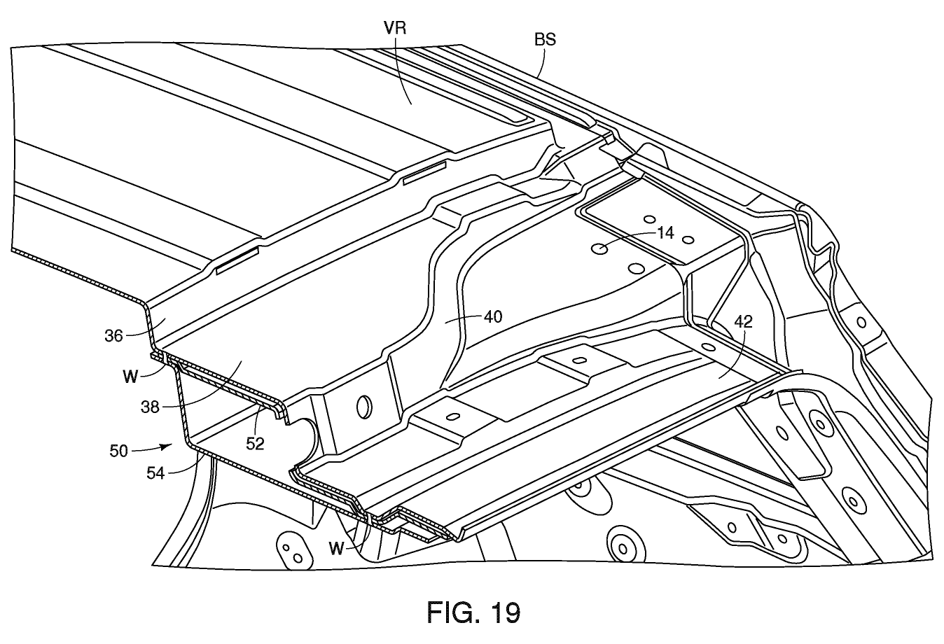

As illustrated o FIGS. 5-7 and 16-19, the first structure 52 has a similar configuration as the roof panel 14. For example, the first structure 52 can be generally made of metal, but can be any suitable material. As illustrated in FIG. 5, a first portion 56 of the first structure 52 is generally parallel to the vehicle roof VR. A second portion 58 extends downwardly at an angle and a third portion 60 extends generally parallel to the roof. The first portion 56 of the first section 52 is generally parallel to the second portion 38 of the roof panel 14. That is, as illustrated in FIG. 5, the second portion 38 of the roof panel 14 generally overlies and has the same shape as the first portion of the first section 52 of the roof bow 12. The second portion 58 of the first section 52 is generally parallel to the third portion 40 of the roof panel 14. The third portion 40 of the roof panel 14 generally overlies and has the same shape as the second portion 58 of the first section 52 of the roof bow 12. The third portion 60 of the first section 52 is generally parallel to the fourth portion 42 of the roof panel 14. That is, as illustrated in FIG. 5, the fourth portion 42 of the roof panel 14 generally overlies and has the same shape as the third portion 60 of the first section 52 of the roof bow 12. In one embodiment, the fourth portion 42 of the roof panel 14 can extend farther in the rearward longitudinal direction L than the third portion 60 of the first section 52.

Similarly to the second portion 38 of the roof panel 14, the first portion 56 of the first section 52 of the roof bow 12 has a curved configuration, and defines at least part of the an exterior surface of the cross member 50. As illustrated in FIG. 17, the first portion 56 has a first side portion 62a, a central portion 64 and a second side portion 62b , such that the central portion 64 of the first portion 56 is closer to the rear door opening O than the ends or sides (first and second side portions 62a and 62b) of the first portion 56. The second portion 58 can also have openings 66 for electrical wiring and/or hydraulic conduits for the motors M and the hinges structure as can be understood. In one embodiment, the first section 52 can be attached to the vehicle roof VR. For example, as illustrated in FIG. 17, the first section 52 can include attachment flanges 68 that are configured to have the vehicle roof VR attach thereto. However, it is noted that the first section 52 can be connected to the vehicle roof VR in any suitable manner. The first portion 56 of the first section 52 is generally parallel to the second section 38 of the roof panel 14.

As can be understood, the first structure 52 forms a recessed area or cavity 70 defined by the exterior surface 72 thereof. The cavity 70 can be an opening in the rearward direction of the vehicle V. This cavity 70 is generally covered by the roof panel 14 and can have the hinge structures HS and the motors M mounted therein, in the same manner as discussed herein. Furthermore, the cross member 50 includes an interior surface 73 opposite the exterior surface 70 and a cavity 75 is formed by the interior surface 73. The cavity 75 is basically formed by the first structure 52 and a the second structure 54 and is the interior of the rectangular structure.

The second structure 54 of the roof bow 12 is formed from metal and has a generally L-shaped configuration. As illustrated in FIGS. 5-7, the second structure 54 is disposed adjacent the rear opening or cavity 70 and is attached to the vehicle body structure BS. The first structure 52 is coupled to the second structure 54 and together form the roof bow 12. As can be understood, the roof bow 12 can be a structural component of the vehicle V and is configured to support the roof and the roof panel 14.

The second structure includes a first portion 74 and a second portion 76. The first portion extends from the first portion 56 of the first structure 52 in a downward direction. The second portion 76 of the second section 54 extends generally transverse to the first portion 74. Thus, the first section 52 and the second section 54 form a generally rectangular configuration which provides significant structural benefit to support the vehicle roof VR. The second section 52 includes flanges 78 attached to the first portion 74 that correspond to the flanges 68 of the first structure 52 and facilitate both the coupling of the first and second structures 52 and 54 and the roof bow 12 to the vehicle roof VR. The roof bow 12 can be connected to the roof in any suitable manner using any suitable fasteners, such as screws, snap fit structures or any other suitable device. For example. The roof bow 12 or the cross member 50 of the roof bow 12 can be welded to the roof and/or the vehicle body structure BS.

As can be understood, the second structure 54 of the roof bow 12 can be attached to the vehicle body structure BS. The first structure 52 of the roof bow 12 is then coupled to the second structure 54 of the roof bow 12. The combination of the first and second structures 52 and 54 for a cross member 50 that is configured to support the vehicle roof VR and the roof module 10. As discussed herein, the rectangular structure of the roof bow 12 is a preferred structural configuration, since the configuration enables light weight components while still providing excellent rigidity and support.

As can be understood, the roof bow 12 can be part of the vehicle body structure BS. Thus, the vehicle body structure BS can includes the vehicle roof VR (roof structure), the rear door opening O, a roof panel 14, a cross member 50 configured to be disposed below the roof panel 50 of the vehicle body structure BS, with the cross member 50 having an exterior surface 72, and a hinge structure HS attached to the exterior surface 72 of the cross member 50.

The vehicle roof VR and the roof panel 14 can be attached to the vehicle body structure BS (for example the side structures SS) and the roof bow 12. The rear door components (e.g., hinge structure HS and motors M) can be attached to the exterior surface (fourth portion 42) of the roof panel 14 and/or the exterior surface (third portion 60) of the first structure 52 of the roof bow 12. For example, the hinge structure HS, the motor M and any other suitable components can be attached to the exterior surface (fourth portion 42) of the roof panel 14 and/or the exterior surface (third portion 60) of the first structure as discussed wherein. The electrical and hydraulic components for operation of the rear door RD can be installed on and through the roof panel 14 and the roof bow 12. As discussed herein, the rear door RD components are positioned within a cavity 70 formed by the roof bow 12 and the roof panel 14 and can be covered by the cover 16.

Accordingly, once the rear door RD components are properly installed and positioned, the cover 16 can be attached to the roof panel 14. As illustrated in FIGS. 5 and 9, the interior surface 32 of the cover 16 can include a flange or protrusion 80 that contacts the exterior surface of the second portion 38 of the roof panel 14. This protrusion 80 extends substantially along the entire length of the interior surface 32 of the cover 16 and provides rigidity to the cover 16. In one embodiment, the protrusion 80 can include a seal or other device to prevent fluids or other materials from entering the interior portion of the roof module 10.

The cover 16 further couples to the inner flanges IF of the hinge structure HSs. As described herein the inner flange IF of the hinge structure HSs can include a seal or other device to prevent fluids or other materials from entering the interior portion of the roof module 10.

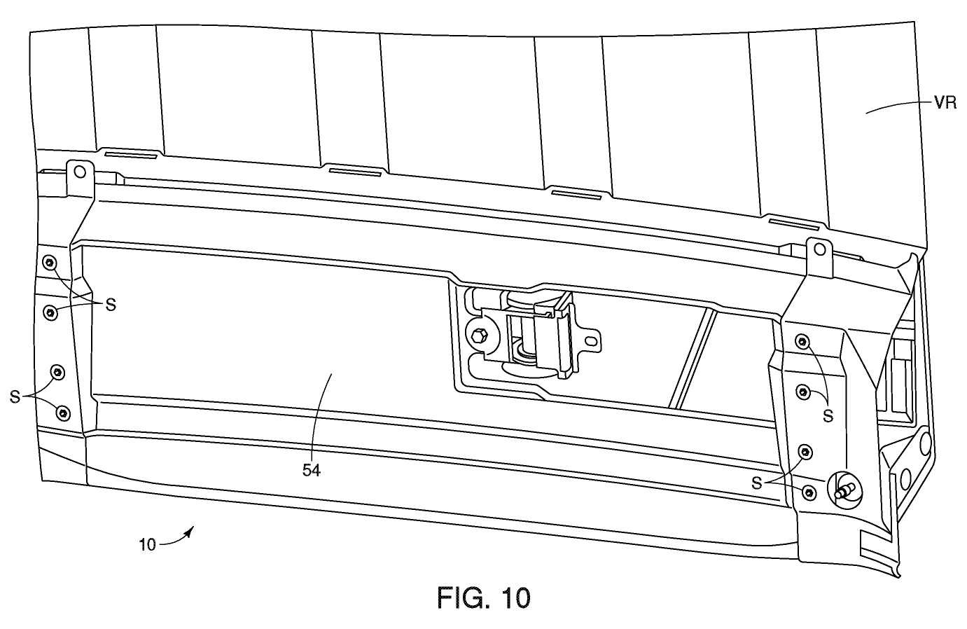

The first portion 18 of the cover 16 can be disposed at the first roof ditch 22 and the second portion 20 of the cover 16 can be disposed at a second roof ditch 24. The cover 16 can be attached to the roof panel 14 using the fastening members and fasteners F that are accessed through the interior of the vehicle V. For example, FIG. 10 is a bottom view of the roof bow 12 from the interior (passenger compartment PC of the vehicle V). Here, several screws S or fasteners can be used to couple to the fasteners 38 of the cover 16. These screws S can be removed exposing the motors, Higers structured HS and other components for access to be maintained or replaced.

Prior to or after connection of the cover 16, the rear door RD can be attached to the hinges structures HS.

By providing a roof module 10 as discussed herein it is possible to improve access to the rear door RD lifting components which can be important to the lifespan of the rear door RD lifting components and the rear door RD of the vehicle V itself.

Furthermore, the roof bow 12 provides a strong rigid structural component of the vehicle V that is capable of providing support to the vehicle, the roof panel 14 and/or the roof module 10. Moreover, the specific configuration provides increased structural rigidity while providing a lightweight component.

The roof bow 12 and the roof module 10 together and separately provide an improve structure for access and operation of a rear door RD and support of a vehicle roof VR.

The hinge structures HS and the motors M are conventional components that are well known in the art. Since the hinge structures HS and the motors M are well known in the art, these structures will not be discussed or illustrated in detail herein. Rather, it will be apparent to those skilled in the art from this disclosure that the components can be any type of structure and/or programming that can be used to carry out the present disclosure.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, "including", "having" and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle V equipped with the roof module 10. Accordingly, these terms, as utilized to describe the present disclosure should be interpreted relative to a vehicle V equipped with the roof module 10.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present disclosure, it will be apparent to those skilled in the art from this disclosure that various changes and modifications can be made herein without departing from the scope of the disclosure as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further disclosures by the applicant, including the structural and/or functional concepts embodied by such feature(s). Thus, the foregoing descriptions of the embodiments according to the present disclosure are provided for illustration only, and not for the purpose of limiting the disclosure as defined by the appended claims and their equivalents.

What is claimed is:

1. A roof bow structure of a vehicle, comprising:
a cross member configured to be disposed below a roof panel of the vehicle, the cross member having an exterior surface, a first side portion, a middle portion and a second side portion; and
a hinge attached to the exterior surface of the cross member.

2. The roof bow structure according to claim 1, wherein
a cavity is formed on the exterior surface.

3. The roof bow structure according to claim 2, wherein
the cavity is open in a rearward direction of the vehicle.

4. The roof bow structure according to claim 1, wherein
the cross member includes an interior surface opposite the exterior surface and a cavity is formed by the interior surface.

5. The roof bow structure according to claim 1, wherein
the hinge is configured to operate a rear door of the vehicle.

6. The roof bow structure according to claim 5, wherein
the middle portion is disposed a first distance from the rear door and the first side portion is disposed a second distance from the door, the first distance being less than the second distance.

7. The roof bow structure according to claim 1, wherein
the cross member forms a gap with the roof panel.

8. The roof bow structure according to claim 1, wherein
the cross member is welded at a top thereof.

9. The roof bow structure according to claim 1, further comprising
a motor disposed on the exterior surface of the cross member, the hinge is configured to be operated by the motor.

10. The roof bow structure according to claim 9, wherein
the cross member is configured to couple to a cover structure, the cover structure configured to cover the motor.

11. A vehicle body structure, comprising:
a roof structure;
a rear door opening;
a roof panel;
a cross member configured to be disposed below the roof panel of the vehicle body structure, the rear cross member having an exterior surface; and
a hinge attached to the exterior surface of the cross member.

12. The vehicle body structure according to claim 11, wherein
a cavity is formed on the exterior surface.

13. The vehicle body structure according to claim 12, wherein
the cavity is open in a rearward direction of the vehicle body structure.

14. The vehicle body structure according to claim 11, wherein
the cross member includes an interior surface opposite the exterior surface and a cavity is formed by the interior surface.

15. The vehicle body structure according to claim 11, wherein
the hinge is configured to operate a rear door.

16. The vehicle body structure according to claim 15, wherein
the cross member has a first side portion, a middle portion and a second side portion, the middle portion disposed a first distance from the rear door and the first side portion is disposed a second distance from the door, the first distance being less than the second distance.

17. The vehicle body structure according to claim 11, wherein
the cross member forms a gap with the roof panel.

18. The vehicle body structure according to claim 11, wherein
the cross member is welded at a top thereof.

19. The vehicle body structure according to claim 11, further comprising
a motor disposed on the exterior surface of the cross member, the hinge is configured to be operated by the motor.

20. The vehicle body structure according to claim 19, wherein
the cross member is configured to couple to a cover structure, the cover structure configured to cover the motor.
